(19) United States
(12) Patent Application Publication
(10) Pub. No.: US 2008/0149629 A1
(43) Pub. Date: Jun. 26, 2008

(54) Microwave Oven With a Mask For Wave Trap

(75) Inventor: Gerard Beausse, Charenton (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/911,819

(22) PCT Filed: Apr. 18, 2006
(86) PCT No.: PCT/US2006/014775

§ 371 Date: Oct. 18, 2007

(30) Foreign Application Priority Data
Apr. 22, 2005 (FR) 0504049
Apr. 18, 2006 (US) PCT/US2006/014775

(51) Int. Cl. H05B 6/76

(52) U.S. Cl. 219/741

(57) ABSTRACT

The invention relates to a microwave oven comprising a cooking cavity (3) for foods, closed by a pivoting door (10) coming into contact with the framing (21) of the cavity. The door includes a wave trap (160) formed of a metal frame the sides of which are hollow and of rectangular section with a side in the form of a strip (163) arranged, in the closed position of the door, parallel with the lateral wall (20) of the cavity and with a free edge parallel with the edge of the door and at a distance from a frame (147) of this.

The invention is characterised by the fact that a mask (180) made of flexible material covers the said strip (163) so as to mask the said sides of the frame (160).

The present invention relates to the field of ovens for cooking or heating foods by means of microwaves and in particular to a door arrangement including a wave trap.

Microwave ovens are formed of a cooking chamber consisting of a generally parallelepipedal cavity open on one face. A door is mounted on hinges along one side and pivots between an open position allowing access to the cavity and a closed position during operation of the oven. A means for generating hyperfrequency waves transforms electrical energy into electromagnetic energy by which the foods are heated.

Professional “grande cuisine” ovens exist of relatively large capacity, greater than 150 litres, which are combi. They combine at least heating by convection or by steam with heating by microwaves. Heating by convection is effected by means of a gas burner or of one or more electrical resistances. Heating by steam comprises inside the cavity, in accordance with one example, at least one fan associated with an electrical resistance or a gas burner with production of steam. In accordance with another example, the steam is provided by an external boiler.

For these latter ovens in particular, the door is locked in contact with the framing of the cavity with interposition of a peripheral rubber seal. There exists a risk of escape of microwaves through the space between the metal frame of the door and the framing of the cavity. It is imperative to eliminate this risk due to the danger of microwaves to the human body. In order to palliate this risk, a microwave trap is arranged around the periphery of the door which co-operates with the framing against which the door is in contact.

In accordance with a known embodiment for combi ovens, there is a metal frame which is attached to the door panel. The door panel included a protuberant part which comes into the oven cavity. The metal frame is made of sheet metal; each side of the frame has a rectangular section with, on the outside, a parallel strip at a determined distance from the lateral wall of the oven. This strip also includes slots arranged at determined intervals and generally oriented perpendicularly to the plane of the door.

This wave trap is thus configured as a function of the microwaves which are propagated and reflected inside the oven chamber.

In that it is open on one side, the metal frame of the wave trap does however have the disadvantage of forming a zone for deposition of grease vapours or other food residues circulating in the chamber when the oven is in operation and the foods are brought to cooking temperature. Moreover, the inside of the frame is not easily accessed for cleaning.

A need therefore exists to make maintenance of the oven easier.

In accordance with the invention, the microwave oven comprising a cooking cavity for the foods, closed by a pivoting door coming into contact against the framing of the cavity opening, the door including a wave trap formed of a metal frame the four sides of which are hollow and of rectangular section with a side in the form of a strip arranged, in the closed position of the door, parallel with the lateral wall of the cavity and with a free edge parallel with the edge of the door and at a distance from its panel, is characterised by the fact that a mask of flexible material covers the said strip so as to mask the sides of the said frame.

The problem of cleaning is thus simply resolved without detriment to the efficiency of the wave trap.

An embodiment of the invention is now described with reference to the attached drawings in which

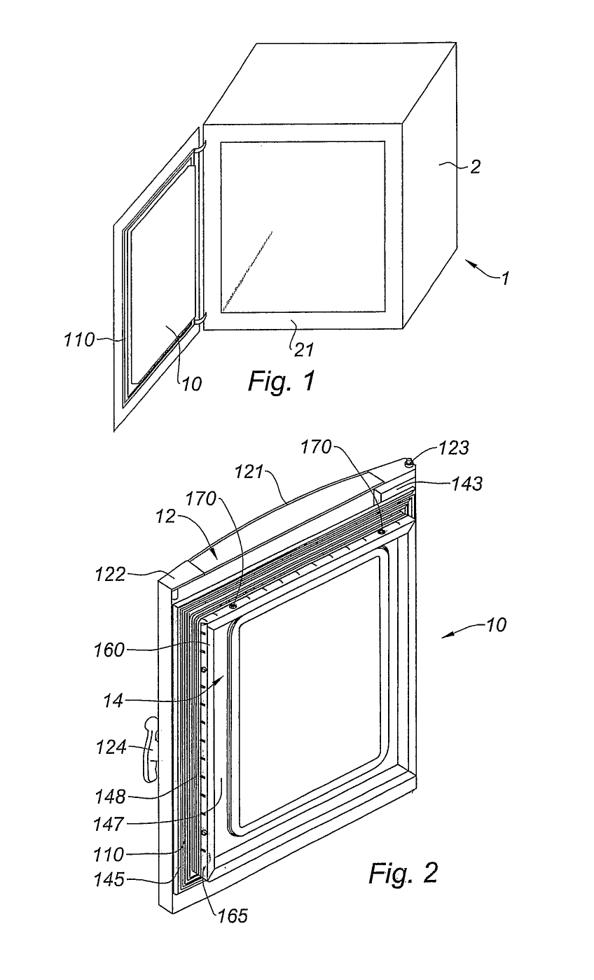

FIG. 1 shows diagrammatically the elements of a microwave oven,

FIG. 2 is a perspective view of the door of FIG. 1 without the mask in accordance with the invention,

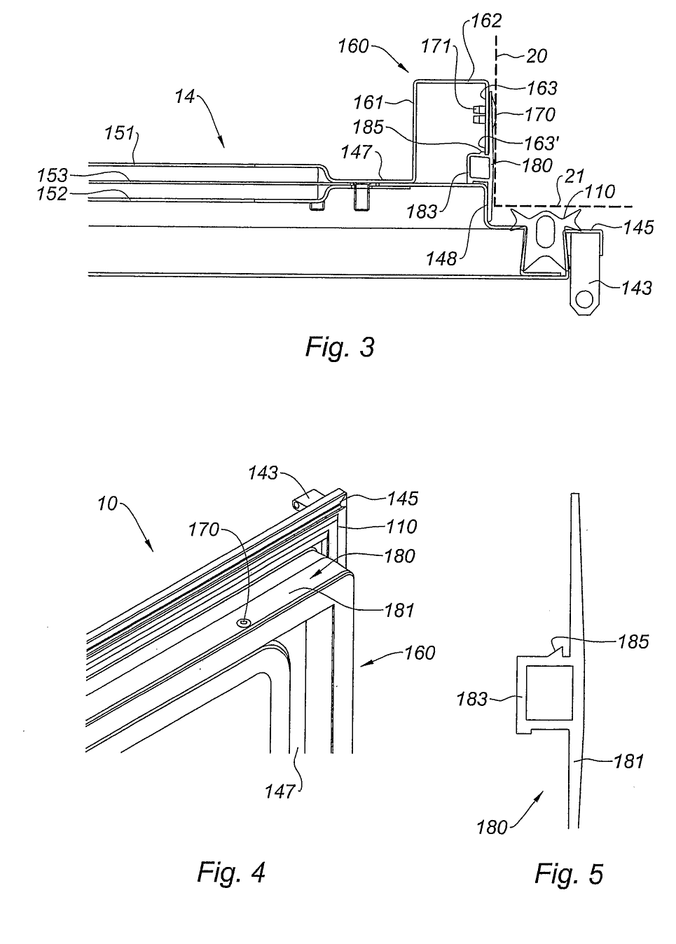

FIG. 3 is a partial view of the door of FIG. 2 on which the seal has been placed,

FIG. 4 is a view in section in the direction IV-IV of FIG. 3,

FIG. 5 is a view in section of an embodiment of the mask of the invention.

FIG. 1 shows an oven 1 comprising a metal case 2 with a cavity 3 of parallelepipedal form. The cavity is open at the front. In the wall of the case 2 are arranged the means for generation of microwaves, comprising at least one magnetron. In the case of a combi oven with heating by convection, electrical resistances are arranged inside the cooking cavity. The combi oven can optionally include a boiler with a steam generator and a gas burner. This itself being known, they are not shown here. The door 10 is hinged about a vertical axis by hinges arranged along a vertical edge of the opening of the cavity. The hinging could also be horizontal. The door 10 includes a peripheral seal 110 to hermetically seal the cooking chamber. The door comes into contact with its seal against the framing 21 of the front face of the case. This framing is flat. The door also comprises a protruding part which comes into position inside the cavity when the door is in contact against the front face of the edge of the cavity with its seal 110.

The door 10 is described in more detail with reference to FIG. 2, which shows it not mounted on the oven. This door 10 comprises an outer door 12, here convex, with a glazing 121 held in a metal frame 122. The outer door pivots about a vertical axis, being held on the oven by pivots 123 cooperating with hinges firmly attached to the case. A handle 124 allows manipulation of the door 10. The metal frame 122 carries an inner door 14. This inner door 14 can open relative to the outer door by pivoting about a vertical shaft held by hinges 143. There is thus access to the space between the two inner and outer doors, for cleaning.

The inner door 14 which is shown in more detail in FIG. 3 comprises a peripheral frame 145 with a seal 110 made of silicone or any other equivalent material. The frame 145 is dimensioned to come into contact against the front face of the framing 21. This seal 110, as shown in FIG. 3, is housed in a channel formed in the frame 145.

The frame 145 includes an inner protuberant frame 147 with a connecting edge 148. The edge 148 is perpendicular to the plane of the frame 145. The dimensions of the inner frame 147 with its edge 148 allow it to be housed in the cavity 3 when the door is closed. The frame 147 carries a window, here composed of two panes 151 and 152, between which is arranged a grating 153 for stopping electromagnetic waves. The wave trap is formed, as is itself known, of a metal frame 160 made of sheet metal fixed to the periphery of the inner frame 147. The frame 160 is formed of four sides of rectangular section, with an inside face 161 perpendicular to the plane of the frame 147 and by which it is fixed to this. The sheet metal forming the face 161 is bent at right angles to form the front face 162 parallel with the plane of the frame 147. The sheet metal is again bent at right angles to form the outside face forming a strip 163. This strip is in the extension of the connecting edge 148. The strip 163 includes a free edge 163′ distant from the plane of the frame 147. The strip 163 also includes slots 165 oriented perpendicularly to the plane of the face 147 at uniform intervals. These slots 165 are shown in FIG. 2. The exact geometry of the frame 160 and its dimensions are determined as a function of the microwaves which have to be stopped. This is itself known.

In FIG. 3, the case of the oven is shown in broken lines with its front face 21 and the adjacent inner lateral wall 20. The strip 163 is kept at a distance from the inner lateral wall 20 of the cooking cavity by spacers 170 which comprise a head coming into contact with the wall 20 and a split fixing stem 171 which is housed in the slots 165. FIG. 2 shows two spacers 170 per side of the frame forming the wave trap.

FIG. 2 shows the door not fitted with the mask in accordance with the invention. It will be understood that in operation the strip and the cavity in the sides of the metal frame allow materials suspended in the confined atmosphere of the oven to be deposited. These elements have little accessibility for cleaning.

In accordance with the invention, the frame is closed by a flexible seal 180 which forms a mask, made of silicone for example, which is not sensitive to the temperatures at which the oven is able to operate. This mask 180, which has been shown in cross-section in FIG. 5, includes a part 181, substantially flat on the outside, which covers both the edge 148 and the strip 163. It includes an interior pad 183 which is housed in the space formed between the free edge 163′ of the strip 163 and the plane of the frame 147. The pad 183 is preferably hollow, as in FIG. 5. It includes a rib 185 which comes into engagement with the free edge 163′ of the strip 163 to retain the mask against this. As shown in FIG. 3, the mask 180 has a smooth surface which can easily be cleaned when necessary, while masking the access to the cavity formed inside the sides of the frame 160.

1. Microwave oven comprising:
a cooking cavity for foods, closed by a pivoting door coming into contact with framing of the cavity, the door including a wave trap formed of a metal frame and the sides of which are hollow and of rectangular section with a side in the form of a strip arranged, in the closed position of the door, parallel with the lateral wall of the cavity and with a free edge parallel with the edge of the door and at a distance from a frame of the latter, wherein a mask made of flexible material covers said strip so as to mask said sides of the frame.

2. Oven as described in claim 1, the mask of which includes a pad interposed between the free edge of the strip and the frame of the door.

3. Oven as described in claim 1, the door of which includes a door frame with a portion of wall parallel with the lateral wall of the oven cavity when the door is closed, the said mask covering the said wall portion.

4. Oven as described in claim 1, said strip of the metal frame of which includes a plurality of slots, spacers are attached in the said slots to keep the strip at a determined distance from the wall of the oven, when the door is in the closed position.

5. A microwave oven, the oven comprising:
a cavity comprising a framing and walls;
a pivoting door that closes the cavity by coming into contact with the framing of the cavity, the door comprising a frame and a wave trap, the wave trap comprising:
a metal frame having hollow sides of rectangular section and a strip that, when the door is in closed position, is parallel with the lateral wall of the cavity and has a free edge parallel to the edge of the door and at a distance from the door frame; and
a mask made of flexible material that covers the strip so as to mask the sides of the door frame.
